(19) United States
(12) Patent Application Publication
(10) Pub. No.: US 2008/0098649 A1
(43) Pub. Date: May 1, 2008

(54) Decorative coatings for plants and plant materials

(76) Inventors: Bobby Lewis Neal, Rock Hill, SC (US); Michael Sylvia, Dart, MA (US); Kumar Dighe, Charlotte, NC (US); Roger Weisburg, Kannapolis, NC (US); Wayne Rector, Rock Hill, SC (US)

Correspondence Address: FISH & RICHARDSON PC, P.O. BOX 1022, MINNEAPOLIS, MN, 55440-1022, US

(21) Appl. No.: 11/903,731

(22) Filed: Sep. 24, 2007

Related U.S. Application Data
(60) Provisional application No. 60/846,963, filed on Sep. 25, 2006.

(51) Int. Cl. A01G 7/06

(52) U.S. Cl. 47/57.7

(57) ABSTRACT

Decorated plants or plant materials are disclosed that include a flower and/or leaf with a crosslinked decorative coating extending from a portion of the flower and/or leaf. The coating is applied as a water-based material and imparts color, texture and/or gloss unusual to the native plant or plant material. Methods are also described.

### CROSS-REFERENCE TO RELATED APPLICATION

This application claims priority from U.S. Provisional Patent Application Ser. No. 60/846,963, filed on Sep. 25, 2006, which is incorporated herein by reference in its entirety.

### TECHNICAL FIELD

This disclosure relates to decorative coatings for plants and plant materials.

### BACKGROUND

Cut flowers and live plants can add color, drama and beauty to their surroundings. For these reasons, cut flowers and live plants are often used ceremonially, for example, at weddings, birthdays and anniversaries. The type of cut flower or live plant used to add color, drama or beauty can be synonymous with the season. For example, lilies are often used in the spring, pumpkins and gourds are often used in the fall, especially around Halloween, and live poinsettias are often used in the winter, especially during the holiday season.

### SUMMARY

Generally, decorated plants or plant materials are disclosed that include decorative coatings.

In one aspect, the disclosure features decorated plants or plant materials that include a flower and/or leaf and a crosslinked decorative coating extending from a portion of the flower and/or leaf. The decorative coating has color, texture and/or gloss unusual to the native plants or plant materials, and it is applied as a water-based material.

In another aspect, the disclosure features decorated plants or plant materials that include a flower and/or leaf and a crosslinked decorative coating extending from a portion of the flower and/or leaf. The crosslinked coating is formed from a water-based material that includes a coating material with an ambient cure crosslinker and, optionally, a colorant.

In some implementations, the ambient cure crosslinker has glass transition temperature of less than about 50° F. (10.0° C.), measured in the crosslinked and/or uncrosslinked state. If desired, the coating material can include one or more other polymeric materials different from the crosslinker that have a glass transition temperature of less than about 50° F. (10.0° C.).

The coating material can include, e.g., a binder or anti-wicking material.

If desired, the decorated plants or plant materials can further include one or more other materials, such as glitter and/or artificial snow, extending from the crosslinked coating.

In another aspect, the disclosure features methods of decorating plants or plant materials. The methods include providing a plant or a plant material; and applying a water-based material that includes a coating material and, optionally, a colorant to the plant or plant material.

The coating material can, e.g., include a crosslinker, e.g., that cures under ambient conditions. For example, the ambient conditions can include temperatures from about 55° F. (12.8° C.) to about 105° F. (40.6° C.), or temperatures from about 60° F. (15.6° C.) to about 95° F. (35.0° C.). In the alternative, or in addition to, the ambient conditions can include relative humidity of between about 25 percent and about 98 percent.

The coating material can also include, e.g., a polymeric material having a glass transition temperature of less than about 50° F. (10.0° C.), e.g., less than about 25° F. (−3.9° C.), or less than about 0° F. (−17.8° C.). In some implementations, the crosslinker, e.g., that cures under ambient conditions, has a glass transition temperature of less than about 50° F. (10° C.), which is measured in the crosslinked and/or uncrosslinked state.

The coating material can, e.g., include a binder.

The coating material can, e.g., include an anti-wicking material.

The water-based material can, e.g., include an emulsifier, e.g., a non-ionic emulsifier.

The water-based material can, e.g., include a biocidal material.

If desired, the water-based material can, e.g., include a rheology modifier, e.g., to provide a desired viscosity.

When the water-based material includes the colorant, the colorant can be, e.g., a dye, such as a fluorescent material and/or a pigment, such as a pearlescent and/or metallic or metal-simulating pigment.

The methods can, e.g., further include applying another material, such as glitter and/or artificial snow, to the plant or plant material.

The provided plant can be a live plant, such as a potted plant, or a tree. For example, the live plant can be aloe, azalea, amaryllis, American ivy, bird-of-paradise, buttercup, cactus, day lily, Easter lily, hyacinth, hydrangea, ivy, jasmine, morning glory, oleander, poinsettia or Virginia creeper.

Implementations and/or aspects may include one or more of the following advantages. The coatings permit decoration of plants or plant materials with colors, gloss and/or texture that is unusual to the native plant or plant materials. The colors, gloss and/or textures can be exciting and can “wow” a viewer with enhanced “bling bling”. The colors are colorfast and generally do not run or wash off, for example, when the live plant is fed or watered. The coatings can be applied in a single step, often reducing time-consuming and costly multiple steps. The coatings can allow for unusual branding and marketing opportunities. For example, plants can be decorated according to the season or holiday. For example, plants can be painted orange and/or black during Halloween or can be painted with festive colors and/or textures that simulate snow and/or ice in the winter. The coatings can be applied to a variety of plants, including chrysanthemums, roses and poinsettias, without harming the plants. The coatings themselves and the solutions in which they are applied generally include little or no organic solvent, such as ethanol, isopropanol or ketones. The coatings and the solutions in which they are applied are relatively non-toxic. The solutions in which the coatings are applied are sprayed using standard paint spraying guns and compressed air.

“Ambient conditions” as used herein refers to nominal, earth-bound conditions at temperatures in the range of about 45-120° F.

A “water-based material” as used herein is one that does not have more than about 5 percent by weight volatile organic compounds (VOCs).

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference herein in their entirety. In case of conflict, the present specification, including definitions, will control. In addition, the materials, methods, and examples are illustrative only and not intended to be limiting. Other features and advantages of the invention will be apparent from the following detailed description, and from the claims.

### DESCRIPTION OF DRAWINGS

The patent or application file contains at least one drawing executed in color. Copies of this patent application publication with color drawing(s) will be provided by the Office upon request and payment of the necessary fee.

FIG. 1 is a color photograph taken from above a live poinsettia having a gold-colored coating applied to its leaves.

FIG. 1′ is a black and white rendering of the photograph of FIG. 1

FIG. 1A is an enlarged photograph of the poinsettia of FIG. 1.

FIG. 1A′ is a black and white rendering of the photograph of FIG. 1A.

FIG. 2 is a color photograph taken from the side of a sprayer suitable for applying the coating shown in FIGS. 1 and 1A.

FIG. 2′ is a black and white rendering of the photograph of FIG. 2.

FIG. 2A is a color photograph of a compressor suitable for driving the sprayer of FIG. 2.

FIG. 2A′ is a black and white rendering of the photograph of FIG. 2A.

FIG. 3 is an enlarged color photograph taken from above of a live poinsettia having a glossy coating applied to its leaves.

FIG. 3′ is a black and white rendering of the photograph of FIG. 3.

FIG. 4 is an enlarged color photograph taken from above of a live poinsettia having gold glitter on its leaves.

FIG. 4′ is a black and white rendering of the photograph of FIG. 4.

FIG. 5 is a color photograph a live poinsettia having a blue coating on its leaves.

FIG. 5′ is a black and white rendering of the photograph of FIG. 5.

FIG. 6 is a color photograph a live poinsettia having artificial snow on its leaves.

FIG. 6′ is a black and white rendering of the photograph of FIG. 6.

### DETAILED DESCRIPTION

Water-based coating systems are disclosed that are useful for the coloration of plants, e.g., live potted plants having leaves and/or flowers, and plant materials, such as dried flowers or grasses. The water-based coatings can provide color, gloss and/or texture unusual to the native plant or plant material without harming the plant or reducing its life span.

Generally, decorated plants, e.g., live potted plants, or plant materials are provided that include a flower and/or leaf and a decorative coating, e.g., a crosslinked coating, extending from a portion of the flower and/or leaf. The coating is applied as a water-based material.

In some implementations, the water-based material, e.g., a water-based paint, includes a coating material that includes, e.g., a crosslinker and, optionally, a colorant. The crosslinker can provide durability and/or colorfastness to the coating, preventing color leaching and/or migration of color, e.g., when the plant is watered, or when the plant is placed in a moist or humid environment. Often it is desirable that the crosslinker cure under ambient conditions so that the water-based material can be applied to a living plant. However, if the water-based material is applied to non-living plant material, ambient cure is not a requirement. Without a colorant, the water-based material can provide gloss and/or texture unusual to the native plant or plant material. In combination with the colorant, the water-based material can provide beautiful, often powerful, coloration, gloss and/or texture to the plant or plant materials.

In implementations in which the coating material includes a crosslinker that cures under ambient conditions, ambient conditions can include a temperature from about 55° F. (12.8° C.) to about 105° F. (40.6° C.), or from about 60° F. (15.6° C.) to about 95° F. (35.0° C.). In addition, ambient conditions can also include relative humidity between about 25 percent and about 98 percent, e.g., between about 40 percent and about 95 percent.

Examples of crosslinkers include acrylic resins, styrene-acrylic resins, vinyl-acrylic resins, polyvinyl acetate-based resins, polyurethanes, polymers having unreacted isocyanate groups, alkoxysilanes, polycarbodiimides, nitrile latexes, SBR resins, activated vinyl polymers, such as vinyl ethers, vinyl carbonates and vinyl carbamates. Preferred crosslinkers are self-crosslinking, meaning that they do not require a catalyst, such as an acid, base or metal, to initiate the crosslinking process. An example of an ambient cure crosslinker is the vinyl-acrylic copolymer Paranol® VA 903, a self-crosslinking material, having a low glass transition temperature. Paranol® VA 903 is available from Para-Chem Southern, Inc. of Simpsonville, S.C. Other examples of ambient cure crosslinkers are polycarbodiimides, such as those described in Watson, U.S. Pat. No. 4,977,219.

The coating material can include a polymeric material having a glass transition temperature of less than about 50° F. (10.0° C.), e.g., less than about 25° F. (−3.9° C.), less than about 0° F. (−17.8° C.), less than about −20° F. (−28.9° C.), or even less than −45° F. (−42.8° C.). Having a low glass transition temperature material in the formulation provides an adhesive coating on the plant or plant material that is, at least initially, tacky or sticky to the touch. Such a coating allows for application of secondary color and/or texture substances, such as glitter or artificial snow. The low glass transition temperature material can be the crosslinker itself and/or another material different from the crosslinker. When the crosslinker is the low glass transition temperature material or one of the low glass transition temperature materials, the glass transition temperature of the crosslinker is measured in the crosslinked and/or uncrosslinked state.

Examples of low glass transition temperature materials include acrylic resins, styrene-acrylic resins, vinyl-acrylic resins, polyvinyl acetate-based resins, polyurethanes, nitrile latexes, SBR resins, poly(vinyl ethers), poly(vinyl carbonates), poly(vinyl carbamates), polyolefins, polyesters and polyamides. An example of a low glass transition temperature polymeric material is the styrene-acrylic latex material Paranol® JRB-AU-40, which is available from Para-Chem Southern, Inc. of Simpsonville, S.C. Paranol® VA 903 (discussed above) is an example of a low glass transition temperature crosslinking material.

In some implementations, the coating material comprises a binder and/or an anti-wicking material, which can provide colorfastness to the coating prior to set up, resisting color leaching and/or migration of color. Examples of binders or anti-wicking materials include polyesters, such as carboxylated polyesters, polyamides, acrylics, such as poly(acrylic acid) or salts thereof, natural gums, such as guar and locust bean gum, starches and alginates. Specific examples of binders and/or anti-wicking materials include Polytech PT 630, a carboxylated polyester available from PolyTech, Inc. (PTI) of Greer, S.C. or Superclear 320N, a poly(acrylic acid)-based liquid binding aid available from Cognis Corporation, Cincinnati, Ohio.

Formulations can include one or more emulsifiers and/or wetting agents, such as non-ionic, anionic, cationic or zwitterionic emulsifiers or wetting agents. Generally, emulsifiers or wetting agents help in dispersing pigments and dyes in the formulations, and can also aid in compatibilizing disparate materials, such as hydrophobic and hydrophilic materials.

Examples of non-ionic emulsifiers and wetting agents include: PEG-20 glyceryl stearate, stearic acid, palmitic acid, PEG-7 hydrogenated castor oil, polyglyceryl-2, dipolyhydroxystearate, ceteareth-12, ceteareth-20, ceteareth-30, PEG-60 hydrogenated castor oil, oleth-30, polyethylene glycol monostearate, and cetearyl alcohol. Still other non-ionic emulsifiers and wetting agents include secondary alcohol ethoxylates, octylphenol ethoxylates, nonylphenol ethoxylates, and alkylamine ethoxylates. Suitable emulsifiers and wetting agents are available from Cognis Corporation and Dow Chemical, e.g., under the tradenames TRITON™ and TERGITOL™.

Ionic emulsifiers can be anionic, cationic or zwitterionic. Examples of anionic emulsifiers include sodium cetearyl sulfate, alkyl diphenyl oxide disulfonates, chelating anionic surfactants and sulfosuccinates. Examples of cationic emulsifiers include quaternary ammonium salts.

Specific emulsification packages are included in Pioneer Pearl Base NA and Pioneer Super Pearl D-A pearlescent printing pastes, available from Pioneer Chemical, Inc. of Greenville, S.C.

Any formulation described herein can include one or more biocidal materials to prevent fungal and bacterial overgrowth in the formulations. Biocides include mixtures of benzylated chlorophenols (Nipacide 10), ortho-benzyl-para-chlorophenol (Nipacide BCP or Chlorophen), alkaline solutions of benzisothiazolinone (Nipacide BIT 10), 1,3,5-tris(2-hydroxyethyl)-hexahydro-s-triazine (Nipacide BK) and mixture of chlorinated xylenols (Nipacide CX 140). Suitable biocides are available from Clariant and Aspen Solutions.

Any formulation described herein can include a rheology modifier and/or a thickener to provide a desired viscosity. Examples of rheology modifiers include poly(acrylic acid)-based modifiers, such as polyelectrolytes derived from poly(acrylic acid). A specific example is Duraconc CSP, available from Premier Color.

When the formulation includes a colorant, the colorant can be dye and/or a pigment. For example, the dye can be a fluorescent or a non-fluorescent material. The pigment can be or can include a fluorescent, a pearlescent and/or metallic or metal-simulating pigment.

In some implementations, the provided plant is a live plant, such as a potted plant, or a tree. For example, the live plant can be aloe, azalea, amaryllis, American ivy, bird-of-paradise, buttercup, cactus, day lily, Easter lily, hyacinth, hydrangea, ivy, jasmine, morning glory, oleander, poinsettia or Virginia creeper.

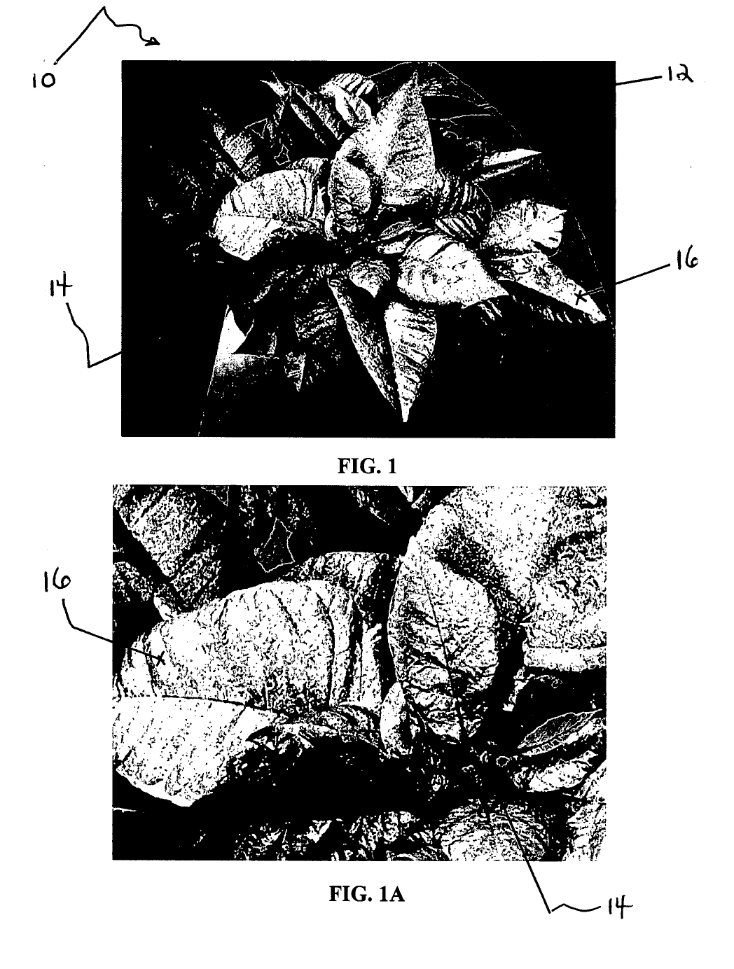

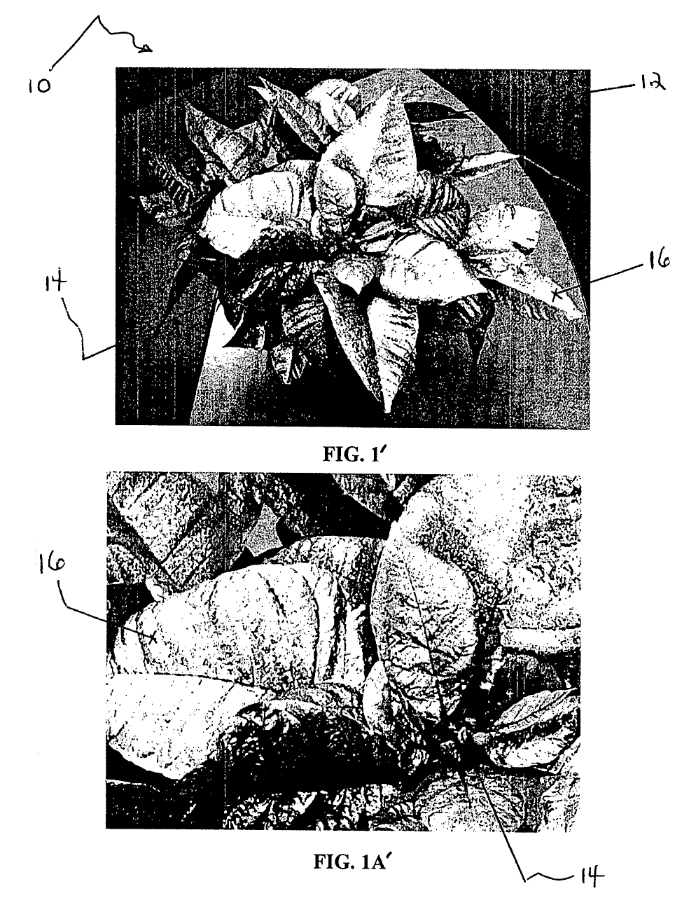

As an example, and by reference to FIGS. 1 and 1A, a decorated poinsettia 10 has red leaves 12 and flowers 14 that have a vibrant, bronze-colored coating 16 extending therefrom. The particular coating shown was applied as a water-based material that included a coating material including an ambient cure crosslinker and the bronze colorant, making the crosslinked coating 16 colorfast and durable.

Generally, the decorated plants or plant materials are made by providing the plant or the plant material, and then applying the water-based formulation that includes the coating material, and, optionally, the desired colorant, to the plant or plant material. For example, the formulations can be sprayed onto the plant using a commercial compressed air sprayer. When a crosslinker is employed in the formulation, it is desirable that the formulation have a working pot life long enough to allow for application of the formulation and clean up of the application device, e.g., sprayer.

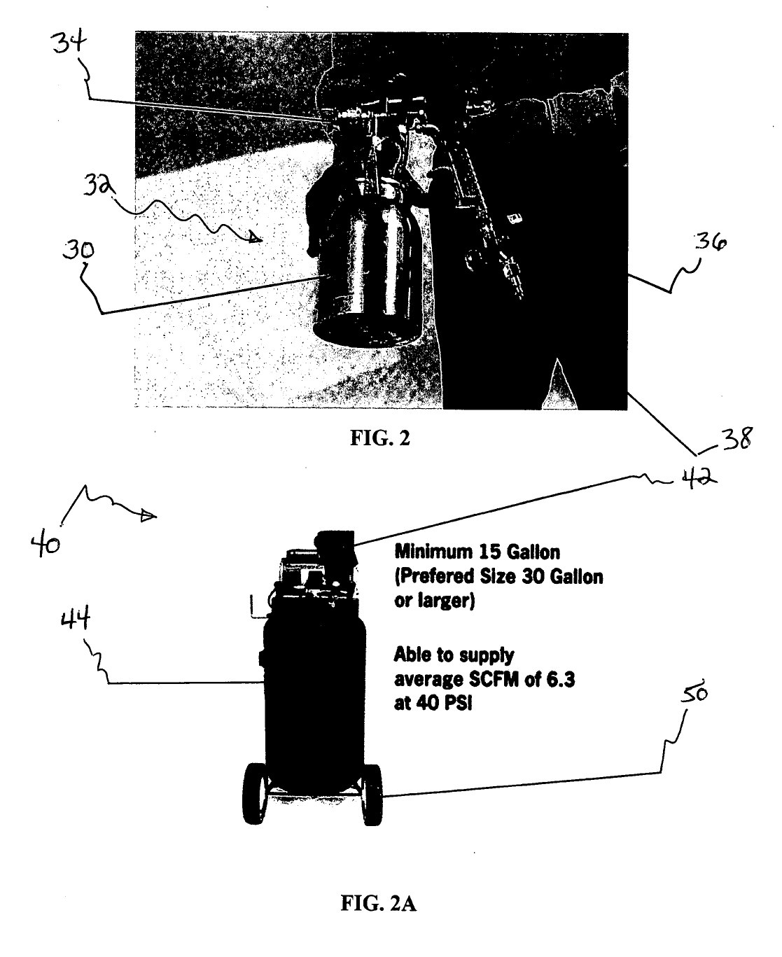

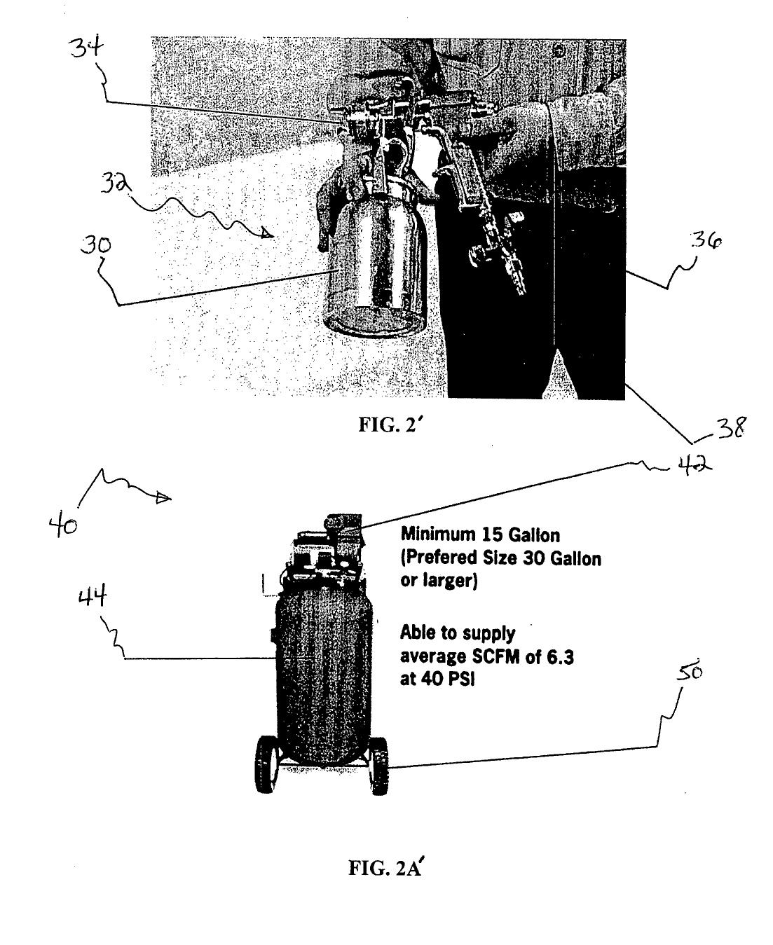

As an example, and by reference to FIGS. 2 and 2A, the decorated poinsettia 10 of FIGS. 1 and 1A can be made by adding the bronze formulation to the liquids container 30 of a spray gun 32 having a nozzle 34 through which the formulation is ejected, a pressure gauge 36 for adjusting ejection pressure, and a coupler 38 to connect the spray gun to the compressor system 40. The compressor system 40 includes an electric motor 42 for compressing the air and a compressed air chamber 44 for containing the compressed air. Because of its weight, it is desirable that the compressor system 40 also include a set of wheels 50 for moving the compressor system 40 to a desired spraying location. Generally, any commercial sprayer driven by a 15-30 gallon air compressor, that can deliver at least 6.3 SCFM of air at 40 PSI is suitable for the spraying the formulations. In embodiments in which a Pro Value Model #2308-PV sprayer is used, which is available from Advance Auto parts, it is desirable to use a pressure setting of from about 18-22 PSI, since settings above 22 PSI can permanently distort the plant or plant material.

### EXAMPLES

The disclosure is further described in the following examples, which do not limit its scope.

Sonostat 28 B (also known as Standapol HS) is a nonionic emulsifier, available from Cognis Corporation, Cincinnati, Ohio.

Polytech PT 630 is a carboxylated liquid polyester binding aid material having about 30 percent by weight solids in water. PT 630 is a hazy amber liquid, typically having pH from about 6.5 to about 6.8 and specific gravity of about 1.05. PT 630 is available from PolyTech, Inc. (PTI) of Greer, S.C.

Superclear 320N a poly(acrylic acid)-based liquid binding aid having about 11 percent by weight solids in water. 320N has nominal pH of about 4.8, nominal specific gravity of about 1.04, and nominal viscosity of 2,250 cps. 320N is available from Cognis Corporation, Cincinnati, Ohio.

Paranol® JRB-AU-40 is a low glass transition temperature styrene-acrylic latex material that is self-crosslinking under ambient conditions, and is provided as a solution/dispersion in water. The milky white liquid typically includes 46.5 percent by weight solids, has pH of about 8.7 and specific gravity of 1.04. JRB-AU-40 is available from Para-Chem Southern, Inc. of Simpsonville, S.C.

Paranol® VA 903 is a low glass transition temperature, self-crosslinking vinyl acrylic copolymer that crosslinks readily under ambient conditions, provided as a solution/dispersion in water. The milky white liquid includes about 50 percent by weight solids, has viscosity of 100 cps (LVT #2 @60), pH of 4.5, bulk density of 8.7 pounds/gallon and surface tension of 40.5 dynes/cm. The material has a glass transition temperature of about −20° C. VA-903 is available from Para-Chem Southern, Inc. of Simpsonville, S.C.

Duraconc CSP is a poly(acrylic acid)-based rheology modifier available from Premier Color. Antiwick AWC is an anti-wicking agent available from Pioneer Chemical, Inc. Nipacide BK is a low toxicity biocide described chemically as a water-born concentrate of 1,3,5-tris(2-hydroxyethyl)-hexahydro-s-triazine. It is a broad-spectrum biocide that protects against fungi and bacteria. It is available from Aspen Solutions. Pioneer Pearl Base NA is a printing paste that includes emulsifiers and wetting agents. It includes about 10 percent solids and has pH of about 9-11. It is available from Pioneer Chemical, Inc. of Greenville, S.C. Pioneer Super Pearl D-A is a pearlescent printing paste for pearlescent colors that includes emulsifiers and wetting agents. It includes about 13 percent solids and has pH of about 9-11. It is available from Pioneer Chemical, Inc. of Greenville, S.C.

Merlin brand name pigments and dyes are available from Engelhard; Ecobrite from Eastern; OBT from Organic; Heucotech from Heucotech; Ajack from Solution Dispersion; Premier from Premier Color; Quinacridone from Spectra; Imperon from Dystar; and Colanyl from Clariant.

All materials in the Examples were used as received.

In Examples 1-24, the water-based materials were prepared by mixing the components of each Example in the order listed (top to bottom) with the aid of a shear mixer, e.g., available from Eppenbach or Hill.

In Examples 25-30, the water-based materials were prepared by first making the RTS Base A (see Example 31) with the aid of a shear mixer, and then combining the RTS Base A with the remaining components of each Example in the order listed (top to bottom). The RTS Base of each Example and the remaining components were mixed with the aid of a shear mixer. The making of the RTS Base A first allows one to weigh out one product, rather than six or more products, making the process faster and more accurate, especially when making small batches of color, e.g. 1-10 gallons of material.

### Example 1

### RTS Blue UM NM-AI

| | Percent (By Weight) |
|---|---|
| Water | 3.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Merlin Magnapearl 3100 | 20.00 |
| Ecobrite Royal Blue R7658 | 12.00 |
| OBT Pig. Violet 4BN 7026 | 2.00 |
| Total | 100.00 |

### Example 2

### RTD Blue 3NN-AI3

| | Percent (By Weight) |
|---|---|
| Water | 12.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Merlin Magnapearl 3100 | 20.00 |
| Heucotech Blue BS 9593 | 5.00 |
| Total | 100.00 |

### Example 3

### RTS Bronze MN-AI

| | Percent (By Weight) |
|---|---|
| Water | 22.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Merlin Super Bronze 9250Z | 15.00 |
| Total | 100.00 |

### Example 4

### RTS Silver NM-AI

| | Percent (By Weight) |
|---|---|
| Water | 22.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Merlin Card Silver BN 001 | 15.00 |
| Total | 100.00 |

### Example 5

### RTS Copper MN-AI

| | Percent (By Weight) |
|---|---|
| Water | 22.30 |
| Sonostat 28B | 3.00 |
| Polytech PT 630 | 20.00 |
| Superclear 320 N | 8.00 |
| Paranol ® JRB-AU40 | 10.0 |
| Paranol ® VA 903 | 20.00 |
| Duraconc CSP | 0.50 |
| Antiwick AWC | 1.00 |
| Nipacide BK | 0.20 |
| Merlin Super Copper 9350Z | 15.00 |
| Total | 100.00 |

### Example 6

### RTS Gold NM-AI

| | Percent (By Weight) |
|---|---|
| Water | 22.30 |
| Sonostat 28B | 3.00 |
| Polytech PT 630 | 20.00 |
| Superclear 320 N | 8.00 |
| Paranol ® JRB-AU40 | 10.0 |
| Paranol ® VA 903 | 20.00 |
| Duraconc CSP | 0.50 |
| Antiwick AWC | 1.00 |
| Nipacide BK | 0.20 |
| Merlin Card Gold BN 002 | 14.00 |
| Merlin Super Bronze 9250Z | 1.00 |
| Total | 100.00 |

### Example 7

### RTS Blue 2NM-AI

| | Percent (By Weight) |
|---|---|
| Water | 13.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Merlin Magnapearl 3100 | 20.00 |
| Premier Blue 2GS-MT | 4.00 |
| Total | 100.00 |

### Example 8

### RTS Fuchsia NM-AI

| | Percent (By Weight) |
|---|---|
| Water | 2.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Merlin Magnapearl 3100 | 20.00 |
| OBT Magenta LDN 6151 | 15.00 |
| Total | 100.00 |

### Example 9

### Lavender NM-AI

| | Percent (By Weight) |
|---|---|
| Water | 13.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Merlin Magnapearl 3100 | 20.00 |
| OBT Pig. Violet 4BN 7026 | 4.00 |
| Total | 100.00 |

### Example 10

### RTS Pearl White NM-AI

| | Percent (By Weight) |
|---|---|
| Water | 17.30 |
| Sonostat 28B | 3.00 |
| Polytech PT 630 | 20.00 |
| Superclear 320 N | 8.00 |
| Paranol ® JRB-AU40 | 10.0 |
| Paranol ® VA 903 | 20.00 |
| Duraconc CSP | 0.50 |
| Antiwick AWC | 1.00 |
| Nipacide BK | 0.20 |
| Merlin Magnapearl 3100 | 20.00 |
| Total | 100.00 |

### Example 11

### RTS White R-AI

| | Percent (By Weight) |
|---|---|
| Water | 7.30 |
| Sonostat 28B | 3.00 |
| Polytech PT 630 | 20.00 |
| Superclear 320 N | 8.00 |
| Parnol ® JRB-AU40 | 10.0 |
| Paranol ® VA 903 | 20.00 |
| Duraconc CSP | 0.50 |
| Antiwick AWC | 1.00 |
| Nipacide BK | 0.20 |
| Premier White R | 30.00 |
| Total | 100.00 |

### Example 12

### RTS Scarlet YDC-AI

| | Percent (By Weight) |
|---|---|
| Water | 25.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| OBT Pig. Scarlet YDC 6019 | 12.00 |
| Total | 100.00 |

### Example 13

### RTS Violet RS-AI

| | Percent (By Weight) |
|---|---|
| Water | 25.30 |
| Sonostat 28B | 3.00 |
| Polytech PT 630 | 20.00 |
| Superclear 320 N | 8.00 |
| Paranol ® JRB-AU40 | 10.0 |
| Paranol ® VA 903 | 20.00 |
| Duraconc CSP | 0.50 |
| Antiwick AWC | 1.00 |
| Nipacide BK | 0.20 |
| OBT Pig. Violet 4BN 7026 | 12.00 |
| Total | 100.00 |

### Example 14

### RTS Black BN-AI

| | Percent (By Weight) |
|---|---|
| Water | 22.30 |
| Sonostat 28B | 3.00 |
| Polytech PT 630 | 20.00 |
| Superclear 320 N | 8.00 |
| Paranol ® JRB-AU40 | 10.0 |
| Paranol ® VA 903 | 20.00 |
| Duraconc CSP | 0.50 |
| Antiwick AWC | 1.00 |
| Nipacide BK | 0.20 |
| Ajack Black 451 NG | 12.00 |
| OBT Pig. Violet 4BN 7026 | 3.00 |
| Total | 100.00 |

### Example 15

### RTS Blue SCO-AI

| | Percent (By Weight) |
|---|---|
| Water | 24.80 |
| Sonostat 28B | 3.00 |
| Polytech PT 630 | 20.00 |
| Superclear 320 N | 8.00 |
| Paranol ® JRB-AU40 | 10.0 |
| Paranol ® VA 903 | 20.00 |
| Duraconc CSP | 0.50 |
| Antiwick AWC | 1.00 |
| Nipacide BK | 0.20 |
| Ecobrite Royal Blue R7658 | 10.00 |
| Premier Blue 2GS-MT | 2.50 |
| Total | 100.00 |

### Example 16

### RTS Blue 3G-AI

| | Percent (By Weight) |
|---|---|
| Water | 27.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Heucotech Blue BS 9593 | 10.00 |
| Total | 100.00 |

### Example 17

### RTS Blue 2G-AI

| | Percent (By Weight) |
|---|---|
| Water | 27.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Premier Blue 2GS-MT | 10.00 |
| Total | 100.00 |

### Example 18

### RTS Orange R-AI

| | Percent (By Weight) |
|---|---|
| Water | 27.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| OBT Pig Orange 01/030 | 10.00 |
| Total | 100.00 |

### Example 19

### RTS Fuchsia MG-AI

| | Percent (By Weight) |
|---|---|
| Water | 25.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Quinacridone Magenta BY-18 | 12.00 |
| Total | 100.00 |

### Example 20

### RTS Red FR-AI

| | Percent (By Weight) |
|---|---|
| Water | 25.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Imperon Red FGC-85 | 12.00 |
| Total | 100.00 |

### Example 21

### RTS Pink BN-AI

| | Percent (By Weight) |
|---|---|
| Water | 27.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Spectra Violet 19 30% Disp. | 10.00 |
| Total | 100.00 |

### Example 22

### RTS Gold, Yellow RN-AI

| | Percent (By Weight) |
|---|---|
| Water | 25.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| OBT Pig. Yellow RN 9013 | 12.00 |
| Total | 100.00 |

### Example 23

### RTS Gold, Yellow RN-AI

| | Percent (By Weight) |
|---|---|
| Water | 24.55 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Colanyl Red F5RK-A | 10.00 |
| Premier Blue 2GS-MT | 1.25 |
| OBT Pig. Brown FEO-SP2 | 1.50 |
| Total | 100.00 |

### Example 24

### RTS Yellow G-AI

| | Percent |
|---|---|
| Water | 25.30 |
| Sonostat 28B | 3.00 |
| Polytech PT 630 | 20.00 |
| Superclear 320 N | 8.00 |
| Paranol ® JRB-AU40 | 10.00 |
| Paranol ® VA 903 | 20.00 |
| Duraconc CSP | 0.50 |
| Antiwick AWC | 1.00 |
| Nipacide BK | 0.20 |
| Premier Yellow 1787 | 12.00 |
| Total | 100.00 |

### Example 25

### RTS Orange R-AI-1

| | Percent (By Weight) |
|---|---|
| Water | 5.00 |
| RTS Base (see Example 31 for RTS Base) | 45.00 |
| Pioneer Pearl Base NA | 40.00 |
| OBT Pigment Orange 01/030 (Orange 16) | 10.00 |
| Total | 100.00 |

### Example 26

### RTS Orange R-AI

| | Percent (By Weight) |
|---|---|
| Water | 28.80 |
| RTS Base (see Example 31 for RTS Base) | 61.20 |
| OBT Pigment Orange 01/030 (Orange 16) | 10.00 |
| Total | 100.00 |

### Example 27

### RTS Fuchsia NM-AI

| | Percent (By Weight) |
|---|---|
| Water | 4.00 |
| RTS Base (see Example 31 for RTS Base) | 45.00 |
| Pioneer Pigment White 740 Liquid | 45.00 |
| Quinacridone Magenta BY-18 | 6.00 |
| Total | 100.00 |

### Example 28

### RTS Fuchisia NM-AI-1

| | Percent (By Weight) |
|---|---|
| Water | 3.80 |
| RTS Base (see Example 31 for RTS Base) | 61.20 |
| Mearlin Megapearl 3100 Color 760 | 20.00 |
| OBT Pigment Magenta LDN6141 | 15.00 |
| Total | 100.00 |

### Example 29

### RTS Bronze NM-AI-1

| | Percent (By Weight) |
|---|---|
| Water | 10.00 |
| RTS Base (see Example 31 for RTS Base) | 45.00 |
| Pioneer Pearl Base NA | 30.00 |
| Mearlin Super Bronze 9250Z | 15.00 |
| Total | 100.00 |

### Example 30

### RTS Bronze NM-AI

| | Percent (By Weight) |
|---|---|
| Water | 23.80 |
| RTS Base (see Example 31 for RTS Base) | 61.20 |
| Mearlin Super Bronze 9250Z | 15.00 |
| Total | 100.00 |

### Example 31

### RTS Base A

| | Percent (By Weight) |
|---|---|
| Sonostat 28B | 4.90 |
| Polytech PT 630 | 32.68 |
| Superclear 320 N | 13.10 |
| Paranol ® JRB-AU40 | 16.34 |
| Paranol ® VA 903 | 32.68 |
| Nipacide BK | 0.30 |
| Total | 100.00 |

### Example 32

### Coating a Live, Potted Poinsettia

One of the desired RTS colors from above is selected and stirred or shaken prior to pouring into the liquids container of a spray gun. Any commercial sprayer that is driven by a 15-30 gallon air compressor, and that can deliver at least 6.3 SCFM of air at 40 PSI is suitable for applying the RTS colors. An commercial sprayer that is suitable is Pro Value Model #2308-PV, which is available from Advance Auto parts.

The plant is sprayed to a desired coverage level. Glitter and/or artificial snow may then be applied within 2-5 minutes of spraying (if desired). If the glitter is not applied shortly after the color, a solution of glue, e.g., a 20 weight percent solution of Paranol® VA-903, can be applied, followed by the glitter and/or artificial snow.

### Other Implementations

A number of implementations have been described. Nevertheless, it will be understood that various modifications may be made without departing from the spirit and scope of the disclosure.

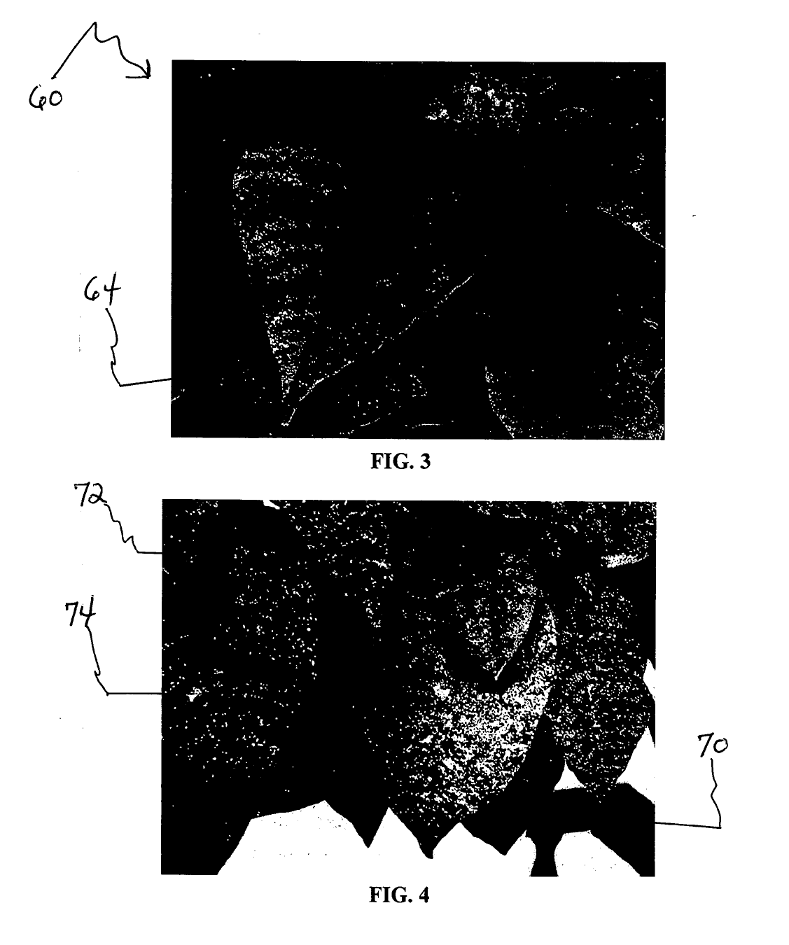

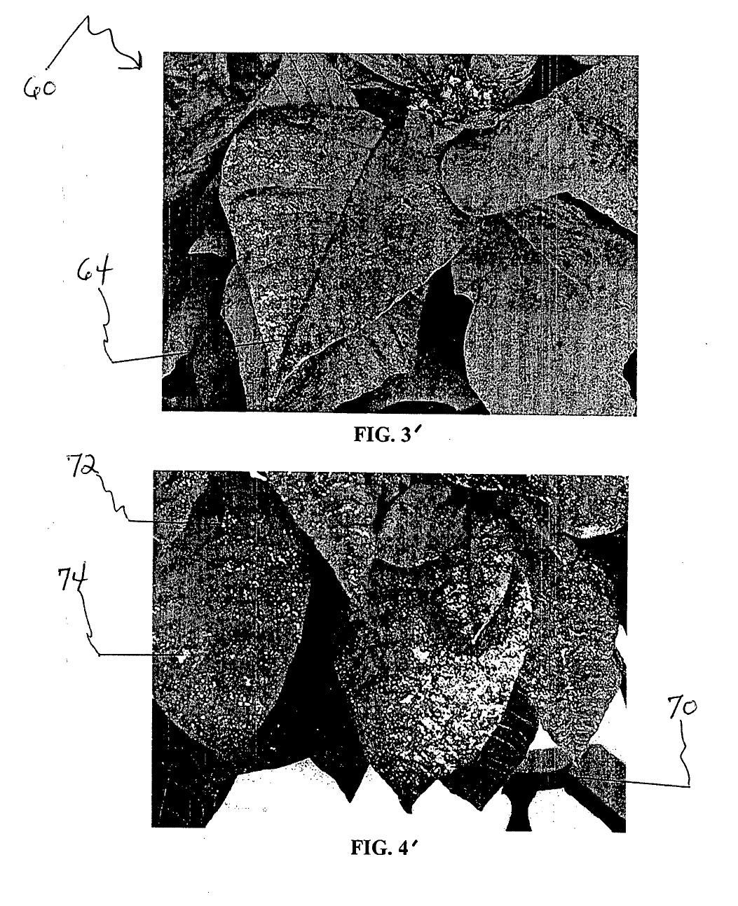

For example, while some of the coatings impart colors to plants or plant materials, some coatings are clear, providing a glossy appearance. For example, and by reference to FIG. 3, a decorated poinsettia 60 has red leaves, some of which have a clear, glossy coating 64. Such a coating can provide an icy look that can invoke feelings associated with winter and cold weather.

If desired, as shown in FIG. 4, glitter 70 in the form of material pieces 72 and 74 of various sizes and degrees of agglomeration can be applied to the glossy coating 64 (FIG. 3) while the glossy coating is still wet and/or tacky.

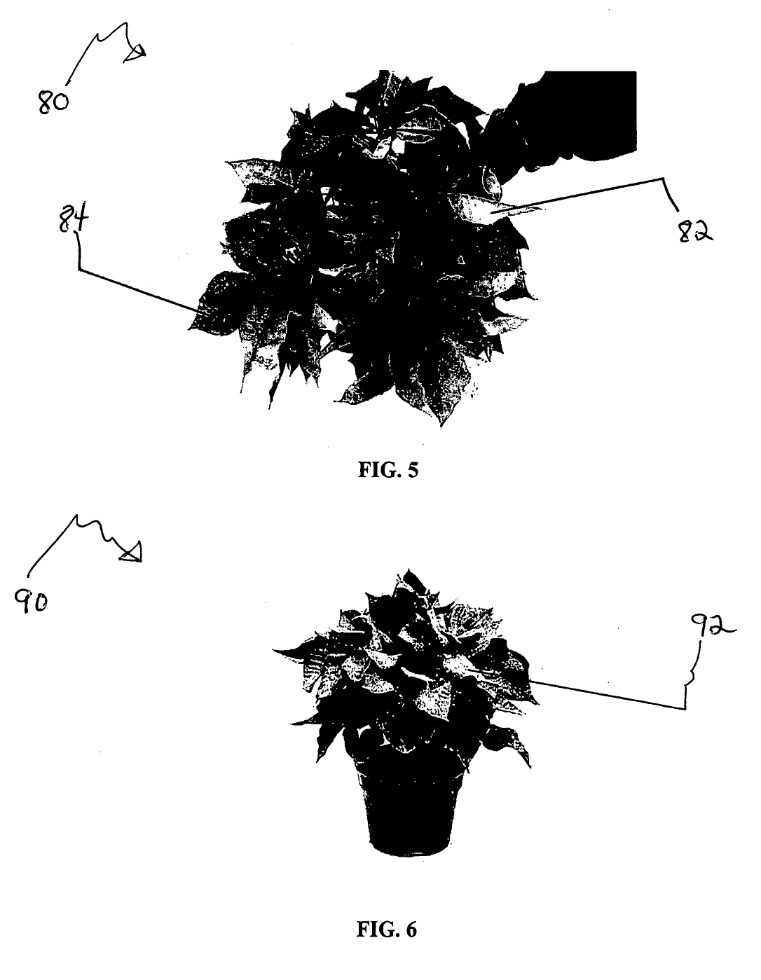

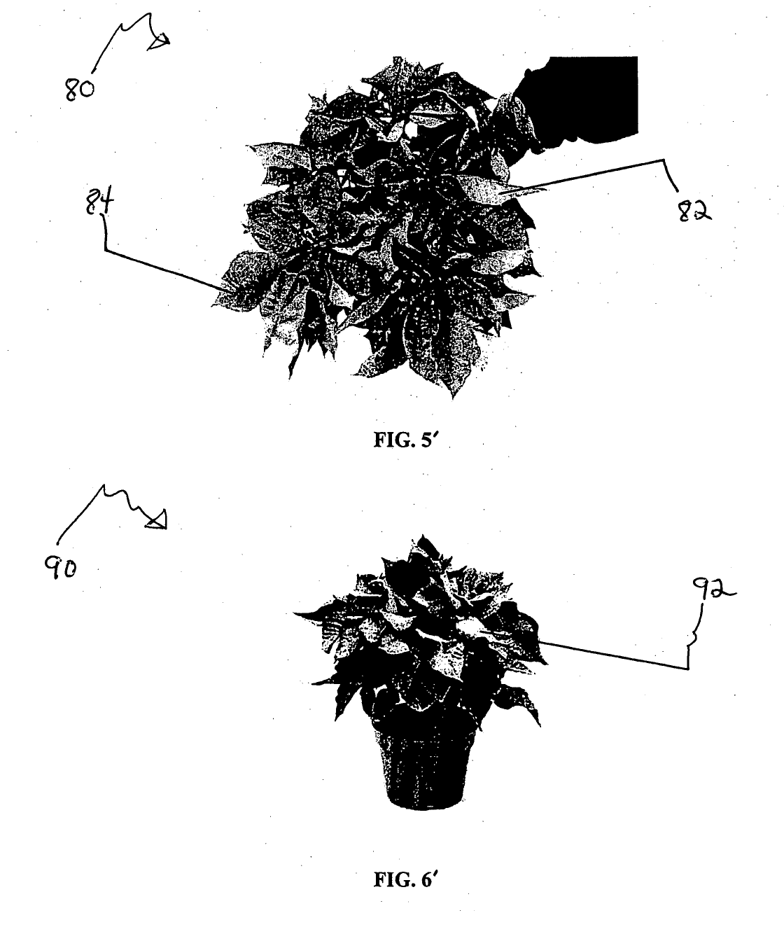

Referring now to FIG. 5, a decorated poinsettia 80 having white or pale leaves 82 can be vibrantly blue-hued with a coating 84 applied in a formulation that includes a vibrant blue color.

If desired, as shown in FIG. 6, artificial snow material 92 in the form of material pieces of various sizes and degrees of agglomeration can be applied to the glossy coating 64 (FIG. 3) while the glossy coating is still wet and/or tacky. This can provide a festive holiday feeling.

Other implementations are within the scope of the following claims.

What is claimed is:

1. A method of decorating a plant or plant material, the method comprising:
providing a plant or a plant material; and
applying a water-based material comprising a coating material and, optionally, a colorant to the plant or plant material.

2. The method of claim 1, wherein the coating material comprises a crosslinker that cures under ambient conditions.

3. The method of claim 2, wherein ambient conditions include temperatures from about 55° F. (12.8° C.) to about 105° F. (40.6° C.).

4. The method of claim 3, wherein ambient conditions include temperatures from 60° F. (15.6° C.) to about 95° F. (35.0° C.).

5. The method of any one of claim 2, wherein ambient conditions include relative humidity of between about 25 percent and about 98 percent.

6. The method of claim 1, wherein the coating material comprises a polymeric material having a glass transition temperature of less than about 50° F. (10.0° C.).

7. The method of claim 6, wherein the coating material comprises a polymeric material having glass transition temperature of less than about 25° F. (−3.9° C.).

8. The method of claim 7, wherein the coating material comprises a polymeric material having glass transition temperature of less than about 0° F. (−17.8° C.).

9. The method of claim 6, wherein the crosslinker that cures under ambient conditions has the glass transition temperature of less than about 50° F. (10° C.) in the crosslinked and/or uncrosslinked state.

10. The method of claim 1, wherein the coating material comprises a binder, such as a carboxylated liquid polyester.

11. The method of claim 1, wherein the coating material comprises a anti-wicking material.

12. The method of claim 1, wherein the water-based material comprises a emulsifier.

13. The method of claim 12, wherein the emulsifier comprises a non-ionic emulsifier.

14. The method of claim 1, wherein the water-based material comprises a biocidal material.

15. The method of claim 1, wherein the water-based material comprises a rheology modifier.

16. The method of claim 1, wherein the water-based material comprises the colorant, and wherein the colorant comprises a dye.

17. The method of claim 16, wherein the dye comprises a fluorescent material.

18. The method of claim 1, wherein the water-based material comprises the colorant, and wherein the colorant comprises a pigment.

19. The method of claim 18, wherein the pigment comprises a pearlescent and/or metallic or metal-simulating pigment.

20. The method of claim 1, further comprising applying glitter and/or artificial snow to the plant or plant material.

21. The method of claim 1, wherein the provided plant is a live plant, such as a potted plant, or a tree.

22. The method of claim 21, wherein the live plant is selected from the group consisting of aloe, azalea, amaryllis, American ivy, bird-of-paradise, buttercup, cactus, day lily, Easter lily, hyacinth, hydrangea, ivy, jasmine, morning glory, oleander, poinsettia, and Virginia creeper.

23. A decorated plant or plant material comprising:
a flower and/or leaf; and
a crosslinked decorative coating extending from a portion of the flower and/or leaf,
wherein the crosslinked coating is applied as a water-based material comprising a coating material comprising an ambient cure crosslinker and, optionally, a colorant.

24. The decorated plant or plant material of claim 23, wherein the ambient cure crosslinker has glass transition temperature of less than about 50° F. (10.0° C.) in the crosslinked and/or uncrosslinked state.

25. The decorated plant or plant material of claim 24, wherein the coating material comprises polymeric material different from the crosslinker that has a glass transition temperature of less than about 50° F. (10.0° C.).

26. The decorated plant or plant material of claim 23, wherein the coating material comprises a binder.

27. The decorated plant or plant material of claims 23, wherein the coating material comprises a anti-wicking material.

28. The decorated plant or plant material of claims 23, further comprising glitter and/or artificial snow extending from the crosslinked coating.

29. A decorated plant or plant material comprising a flower and/or leaf, and a crosslinked decorative coating having color, texture and/or gloss unusual to the native plant or plant material extending from a portion of the flower and/or leaf, wherein the crosslinked coating is applied as a water-based material.
